(19) United States
(12) Patent Application Publication
(10) Pub. No.: US 2003/0048302 A1
(43) Pub. Date: Mar. 13, 2003

(54) Context flags for menus, toolbars, and other UI objects

(75) Inventor: Dennis A. Quan JR., Quincy, MA (US)

Correspondence Address: FLEIT, KAIN, GIBBONS,, GUTMAN & BONGINI, P.L., ONE BOCA COMMERCE CENTER, 551 NORTHWEST 77TH STREET, SUITE 111, BOCA RATON, FL, 33487, US

(73) Assignee: INTERNATIONAL BUSINESS MACHINES CORPORATION, ARMONK, NY (US)

(21) Appl. No.: 09/944,721

(22) Filed: Aug. 31, 2001

(51) Int. Cl. G06F 3/00

(52) U.S. Cl. 345/764

(57) ABSTRACT

A method, system and computer readable medium for programming the UI (User Interface) based on global context flags. The particular state of the program dictates the value of global context flags. These flags in turn are used in a Boolean operation to select which UI objects should be rendered and or made available to the end-user. Programming the desired UI objects for usage is accomplished by attaching attributes for the desired rendering which if favorably compared using the Boolean operation to the global context flags will result in their selection or deselection.

### PARTIAL WAIVER OF COPYRIGHT

All of the material in this patent application is subject to copyright protection under the copyright laws of the United States and of other countries. As of the first effective filing date of the present application, this material is protected as unpublished material. However, permission to copy this material is hereby granted to the extent that the copyright owner has no objection to the facsimile reproduction by anyone of the patent documentation or patent disclosure, as it appears in the United States Patent and Trademark Office patent file or records, but otherwise reserves all copyright rights whatsoever.

### CROSS REFERENCE TO RELATED APPLICATIONS

Not Applicable

### BACKGROUND OF THE INVENTION

1. Field of the Invention

This invention generally relates to the field of the programming of the end-user machine interface, commonly known as a UI (User Interface), and more particularly to the use of a method and system to control the selection and rendering of UI objects.

2. Description of the Related Art

End-user machine User Interfaces (UI) continue to evolve. At an abstract level the end-user has five senses and it is with these that a UI must be optimized with respect to task that the end-user is trying to have the computer accomplish. In many cases, UIs make use of real-life metaphors, such as a desktop or a paper tablet metaphor. There are several UI categories of UI available across various computer platforms. These UIs include:

CUI—Character User Interface is a UI output that present alphanumeric text to a end user across one or more lines of display such as a simple calculator screen. The input device for a CUI is typically a keyboard or numeric keypad. The input to the computer is typed, the output from the computer is typically printing on a screen or a printed page.

GUI—Graphical User Interface is a graphical UI output rather than purely textual such as a CUI. A UI output is presented using a combination of graphics and text. A GUI sometimes uses one or more metaphors for objects familiar in real life, such as the desktop, the view through a window, or the physical layout in a building. Elements of a GUI include such things as: windows, pull-down menus, buttons, scroll bars, iconic images, and wizards. Elements of a GUI may be selected typically with a pointing device such as a mouse and keyboard.

VibUI—Vibration User Interface is a UI output based on the sense of touch rather than the sense of sight as with the CUI and GUI. A vibrating surface is used as an output device to signal an end-user that an item such as a cell phone requires the end user's attention. In an example the end-user has an incoming phone call or a waiting message. Though usually limited to vibrating for short periods of time it is possible to differentiate different simple messages. One long vs several short vibrations can separate a phone call from a message. This type of interface is typically used when an audio ring is considered objectionable such as in a movie theater or at a meeting. The input to the computer is typically to push a button. The output from the computer is typically the vibration as mentioned above.

VUI—Voice User Interface is a UI input based on the using of sound such as the use of the human voice as an input device for command and control of a computer. For example, using an ordered set of known commands a end-user with a microphone enabled computer can cause an application such as a word processor to be selected and then to dictate a memo all with the use of their voice. The output back in a VUI can be by using CUI, GUI, VibUI or synthetic voice.

PUI—Pen User Interface is a UI input using a pen as an input device to enable the command and control of a computer. The use of the pen also allows for recognition of handwriting and other motions by an end user, sometimes called graffiti. The input to the computer is ideally tuned for the pen. Special pen (or paper) presentations allow for electronic paper and ink to be realized. The output from the computer to the end user can be a CUI, GUI, VibUI or synthetic voice.

Each of these UIs described above are useful and exhibit their own advantages and disadvantages depending on the type of use. For example, an engineer doing graphical work such as drawings the pen interface is intuitive. Whereas a lawyer doing the dictation of a memo the voice interface is intuitive. In all of these UIs a computer presents a given method of interfacing and a finite set of possible tasks or selections, which the end-user responds to in the appropriate way. The programming and maintenance of the correct states of UI objects that may be possible can be very labor intensive. In fact as the UI changes from one command to another, UI objects must be added or deleted as the end-user interacts with the computer.

With all UIs a programmer must construct routines to correctly present UI menus. The computer presents UI objects such as icons or audio cues, which must be matched by a programmer to the state of the application program. Many times there can be hundreds or even thousands of combinations of UI objects to present in a complex program such as a word processor. Moreover, it is common in a complex program such as a word processor for the individual's entries in the menu to change depending on the state of the word processor. For example, the “table menu option” may only be presented after a table is inserted into the word processing document. The process of tracking the state of a complex program is labor intensive. For example, when an option is no longer needed for a given state of a application program, typically the programmer removes the option from the menu lists or icons. Optionally, with a visual UI rather than removing the menu list or icon, the menu item can be “grayed-out” or de-emphasized so that they are no longer selectable with a mouse. As mentioned previously, not only is the programming of each application program state combination labor intensive but each combination must be tested. Accordingly, a need exists for an improved method and system for selecting and presenting only the UI objects desired for a given application program state.

Another shortcoming to the present methods and systems to implement state specific UIs is the execution of custom computer code each time the menu must be updated. For example, many systems have a separate routine to display each menu entry on a menu depending on the state of the application program. The use of specialized code for each menu items many times executes slowly while each section of menu code is parsed and executed. Slow and inefficient menu updates are undesirable. Accordingly, a need exists to provide a solution to overcome this shortcoming as well.

Still, another shortcoming with present methods and system used to implement state specific UIs is the skill level required to maintain, create and customized code. Many of the Microsoft Windows programming environments requires programmers with knowledge in C/C+ and other programming languages. The need to change one item state for one menu many times requires that a skilled C/C+ programmer change the code and recompile and re-link the application. The use of skilled programmers is expensive. Accordingly, a need exists for a method and a system to enable the updates of UI objects depending on an application state without the use of programmers.

Yet, still another shortcoming with the present methods and system used to implement state specific UIs is the need to recompile and re-link and application if a state of an application must be revised. This is especially true where one program is written to support a UI in many national languages. Accordingly, a need exists for a method and system to enable updates of UI objects without the need to recompile and re-link the application program.

### SUMMARY OF THE INVENTION

Briefly, according to the present invention, disclosed is a method, a system and computer readable medium for the programming of the content of the end-user interface options based on associating global context flags to all the end-user interface objects and by using a Boolean operation selecting the appropriate end-user interface objects for rendering to the end-user.

### BRIEF DESCRIPTION OF THE DRAWINGS

The subject matter, which is regarded as the invention, is particularly pointed out and distinctly claimed in the claims at the conclusion of the specification. The foregoing and other objects, features, and advantages of the invention will be apparent from the following detailed description taken in conjunction with the accompanying drawings.

FIG. 1 is a block diagram of an exemplary hardware platform with optional components, which is used by the present invention.

FIG. 2 is a block diagram of an exemplary software hierarchy including the present invention that is executed on the hardware of FIG. 1.

FIG. 3 is a functional block diagram of a just opened multi-function application and the associated global context flags, according to the present invention.

FIG. 4 is a functional block diagram of a multi-function application with a text file opened and the associated global context flags, according to the present invention.

FIG. 5 is a functional block diagram of a multi-function application with a text file opened and a table inserted and the associated global context flags, according to the present invention.

FIG. 6 is a functional block diagram of a multi-function application with a text file opened and a just inserted graphic and the associated global context flags, according to the present invention.

FIG. 7 is a flow diagram illustrating the selection of the graphical construct of the User Interface based on the global context flags, according to the present invention.

### DETAILED DESCRIPTION OF AN EMBODIMENT

It is important to note that these embodiments are only examples of the many advantageous uses of the innovative teachings herein. In general, statements made in the specification of the present application do not necessarily limit any of the various claimed inventions. Moreover, some statements may apply to some inventive features but not to others. In general, unless otherwise indicated, singular elements may be in the plural and visa versa with no loss of generality.

In the drawing like numerals refer to like parts through several views.

### DISCUSSION OF HARDWARE AND SOFTWARE IMPLEMENTATION OPTIONS

The present invention as would be known to one of ordinary skill in the art could be produced in hardware or software, or in a combination of hardware and software. However in one embodiment the invention is implemented in software. The system, or method, according to the inventive principles as disclosed in connection with the preferred embodiment, may be produced in a single computer system having separate elements or means for performing the individual functions or steps described or claimed or one or more elements or means combining the performance of any of the functions or steps disclosed or claimed, or may be arranged in a distributed computer system, interconnected by any suitable means as would be known by one of ordinary skill in art.

According to the inventive principles as disclosed in connection with the preferred embodiment, the invention and the inventive principles are not limited to any particular kind of computer system but may be used with any general purpose computer, as would be known to one of ordinary skill in the art, arranged to perform the functions described and the method steps described. The operations of such a computer, as described above, may be according to a computer program contained on a medium for use in the operation or control of the computer, as would be known to one of ordinary skill in the art. The computer medium, which may be used to hold or contain the computer program product, may be a fixture of the computer such as an embedded memory or may be on a transportable medium such as a disk, as would be known to one of ordinary skill in the art.

The invention is not limited to any particular computer program or logic or language, or instruction but may be practiced with any such suitable program, logic or language, or instructions as would be known to one of ordinary skill in the art. Without limiting the principles of the disclosed invention any such computing system can include, inter alia, at least a computer readable medium allowing a computer to read data, instructions, messages or message packets, and other computer readable information from the computer readable medium. The computer readable medium may include non-volatile memory, such as ROM, Flash memory, floppy disk, Disk drive memory, CD-ROM, and other permanent storage. Additionally, a computer readable medium may include, for example, volatile storage such as RAM, buffers, cache memory, and network circuits.

Furthermore, the computer readable medium may include computer readable information in a transitory state medium such as a network link and/or a network interface, including a wired network or a wireless network, which allows a computer to read such computer readable information.

### EXEMPLARY COMPUTER SYSTEM

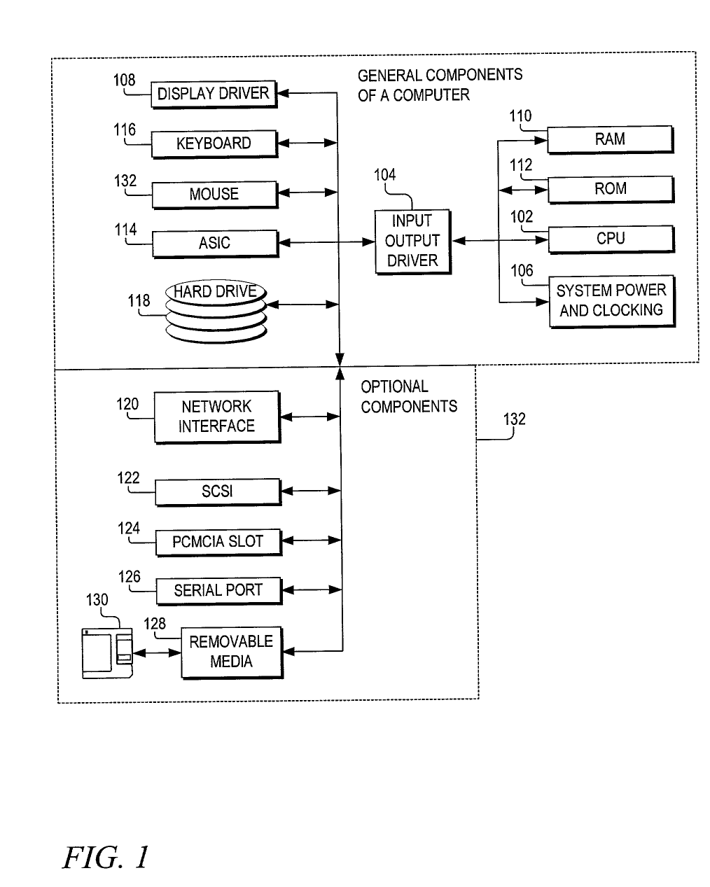

Referring to FIG. 1, there is shown a block diagram 100 of the major electronic components of an information processing system 100 in accordance with the invention. The electronic components include: a central processing unit (CPU) 102, an Input/Output (I/O) Controller 104, a mouse 132 a keyboard 116, a system power and clock source 106; display driver 108; RAM 110, ROM 112, ASIC (Application Specific Integrated Circuit) 114 and a hard disk drive 118. Not shown is a computer display, which is controlled by the display driver 108. These are representative components of a computer. The general operation of a computer comprising these elements is well understood. Network interface 120 provides connection to a computer network such as Ethernet over TCP/IP or other popular protocol network interfaces. Optional components for interfacing to external peripherals include: a Small Computer Systems Interface (SCSI) port 122 for attaching peripherals; a PCMCIA slot 124; and serial port 126. An optional diskette drive 128 is shown for loading or saving code to removable diskettes 130. The system 100 may be implemented by combination of hardware and software. Moreover, the functionality required for using the invention may be embodied in computer-readable media (such as 3.5 inch diskette 130) to be used in programming an information-processing apparatus (e.g., a personal computer) to perform in accordance with the invention.

Given this computer system, the typical software operating system and associated supporting applications can be installed which will simulate and display the results according to the present invention.

### EXAMPLE SOFTWARE HIERARCHY

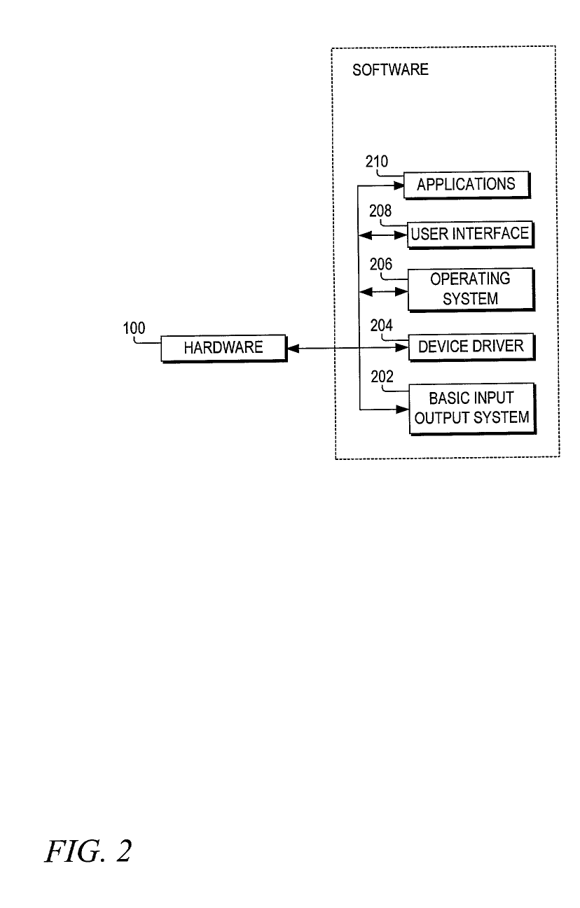

FIG. 2 is a block diagram 200, illustrating the software hierarchy for the information processing system 100 of FIG. 1 according to the present invention. The BIOS (Basic Input Output System) 202 is a set of low level of computer hardware instructions for communications between an operating system 206, device driver 204 and hardware 100. Device drivers 204 are hardware specific code used to communicate between an operating system 206 and hardware peripherals such as a CD ROM drive or printer. Applications 210 are software application programs written in C/C++, assembler or other programming languages. The interface between the end-user and the application 210 is programmed using a particular user interface 208. Typically this is a GUI (Graphical User Interface). Operating system 206 is the master program that loads after BIOS 202 initializes, that controls and runs the hardware 200. Examples of operating systems include Windows 3.1/95/98/ME/2000/NT, Unix, Macintosh, OS/2, Sun Solaris and equivalents.

### DETAILED DESCRIPTION OF THE USAGE OF THE PRESENT INVENTION

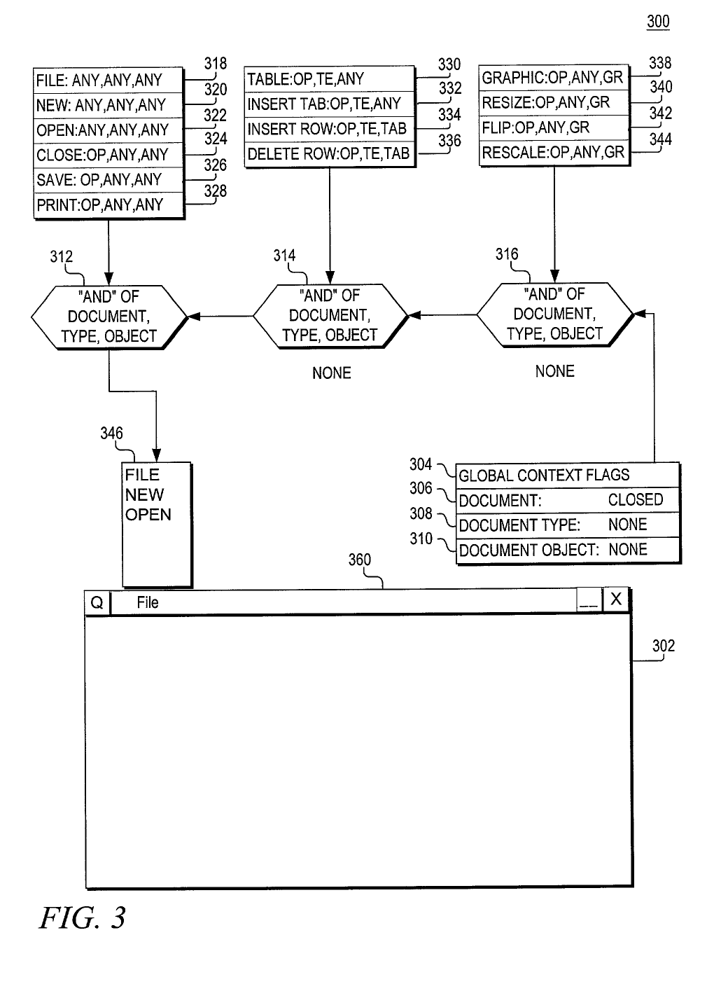

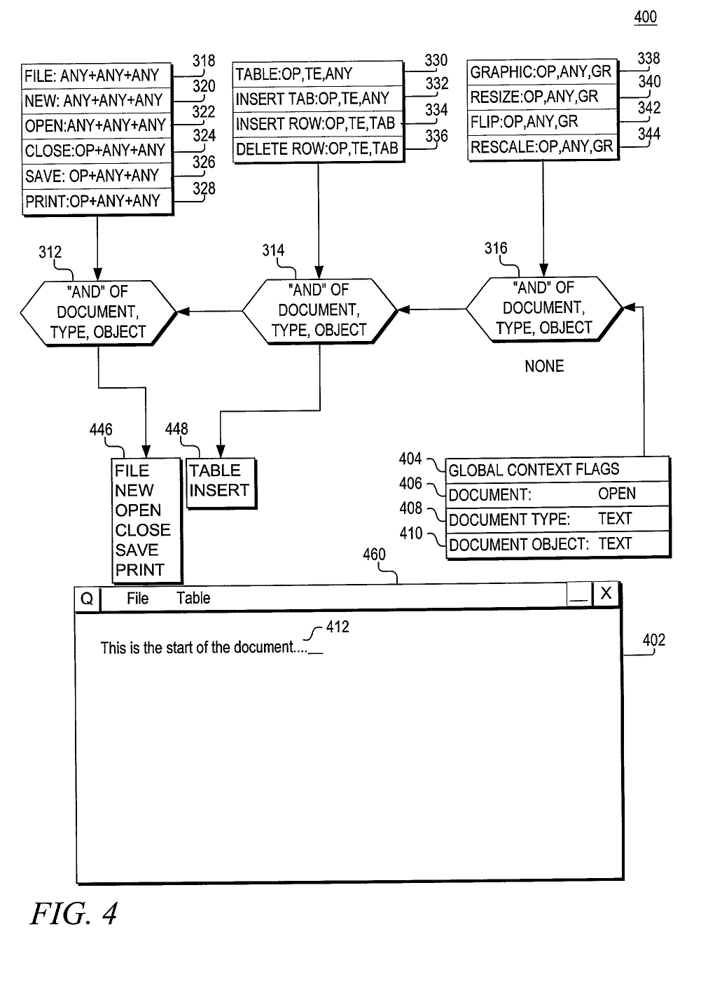

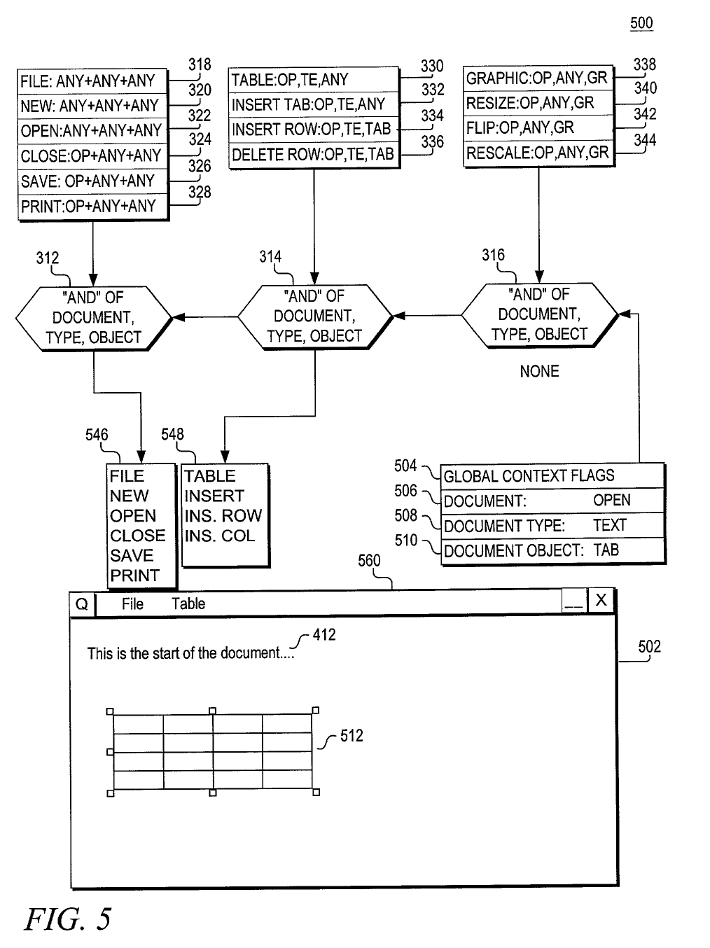

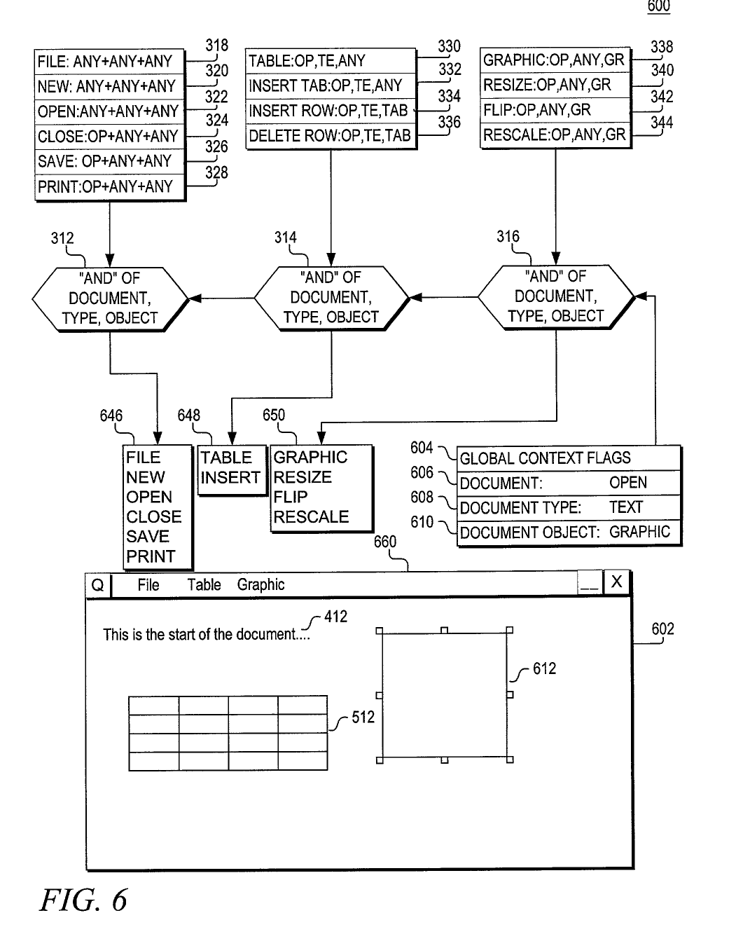

The following figures describe the start of a multi solution application and the use of the present invention. FIG. 3 is the start of the application. FIG. 4 is the opening of a text file. FIG. 5 is the inserting of a table into the text file. Finally FIG. 6 is the selection of a graphic object.

In FIGS. 3-6 below certain abbreviations and definitions are used and are summarized in Table 1 below:

| Abbreviation | Word |
|---|---|
| Any | A wild card that allow a match for “any” |
| OP | Document opened |
| TE | Document file type = Text |
| TAB | Document object type = Table |
| GR | Document object type = Graphic |

### OPENING A MULTI-FILE TYPE APPLICATION SOLUTION

Turning now to FIG. 3 a UI (User Interface) description 300, shows an open application window, global context flags and possible menu lists, according to the present invention. The end-user has opened an application 210, and it is presented to the end-user with a window GUI 302. The application window is shown with no file open. This application is such as Apple Works, Claris Works, Corel WordPerfect Office, Lotus Smart Suite, Sun StarOffice or Microsoft Works. By example Staroffice 5.2 can be used for at lease 15 different task related functions as shown in Table 2 below.

| | |
|---|---|
| Web Browsing | StarBrowser |
| Word Processing | StarWriter |
| Palm Pilot Synchronization | StarSync |
| Spreadsheet | StarCalc |
| Presentation | StarImpress |
| Bit map editor | StanImage |
| Vector Graphic | StarDraw |
| Formula | StarMath |
| Charting | StarChart |
| e-Mail | StarMail |
| News reader | StarDiscussion |
| Scheduling | StarSchedule |
| DataBase | StarBase |
| HTML editor | StarWriter |
| FTP transfers | StarFTP |

This suite of software is implemented across several hardware and software systems so the particular computer platform is not important to the end-user. It is implemented with its own internal implementation of object linking and embedding (OLE), which allows information to be carried seamlessly from one application to another. For example a spreadsheet can be transparently added to a text document without having to switch programs. It can be appreciated that the command list and end-UI for all of these tasks cannot be displayed at the same time. The GUI solution must present the appropriate command list, usually presented in selectable menus if they can be used in the context of the presented active task. Navigation and presenting the UI is only one part of the solution. Each time a task is changed the UI's programming must make all of the correct command calls to render the correct UI objects, and remove those that are no longer needed. As this is a multi platform solution it allows the end-user to decide on a best hardware/software platform (type of computer) that is reliable, fast, and cost effective without the need to relearn a new UI if one changes the type of computer being used.

Continuing with FIG. 3, Table 304 entitled global context flags is defined by the state of the window 302. In the following discussion three flags are being described, however it is understood that there may be more or less flags without departing from the true scope and spirit of the present invention. Further the flags may be nested in structure and usage. This type of labeling can be described as an associative array. An associative array is a set of items, which are randomly accessible by a key, often a string. In this example the global context flags 304 are Document=closed 306, Document Type=none 308 and Document Object=none 310. The global context flags 304, then are: “CLOSED, NONE AND NONE”. These are presented to three possible menu lists file 318, table 330, and graphic 338, and compared using a Boolean AND function at 312, 314 and 316 respectively.

The Boolean comparison is performed on each of the UI objects. In Table 3 below the object column is the menu of file options. Each object has an associative array attached, which defines when the object should be shown along with the type of Boolean operation that should be used. In one embodiment the Boolean AND is used. When the results of the comparisons with the global context flags in the second column are AMD'ed, it can be seen that only file, new and open match (AND requires all of the preconditions to bew matched), and are shown to the end-user in the third column. Not shown are close, save or print.

TABLE 3
Example of the associative array definition and Boolean comparison

| OBJECT | GLOBAL CONTEXT FLAGS | RESULTANT |
|---|---|---|
| file: any, any, any | closed, none, none | file |
| new: any, any, any | closed, none, none | new |
| open: any, any, | closed, none, none | open |
| any | | |
| close: op, any, any | closed, none, none | no match |
| save: op, any, any | closed, none, none | no match |
| print; op, any, any | closed, none, none | no match |

Continuing with FIG. 3, and describing in further detail, the menu list File 318 is AND'ed with the global context flags 304 and as the File menu title 318 is programmed to be presented by associating the associative array “ANY, ANY, ANY”, it will be shown 346 on the file menu in the task bar 360 of window 302. Note that new 320 and open 322 is similarly programmed to be shown 346. However, Close 324, Save 326, and Print 328 is set to be presented by “OP, ANY, ANY” and when AND'ed 312 with the global context flags 304 “CLOSED, NONE, AND NONE” do not match and therefore will not be shown.

The menu list Table 330 is set to be presented by the associated associative array “OP, TE, AND ANY” and when compared 314 to the global context flags 304 do not match and therefore will not be shown. Nor will the Table entries insert tab 338, insert row 334, and delete row 336.

Finally, the menu list graphic 338 is set to be presented by “OP, ANY, GR” associative array and when compared 316 to the global context flags 304 do not match and therefore will not be shown. Nor will the graphic entries resize 340, flip 342 and rescale 344.

In an alternate embodiment for event-based triggering, when the computer is waiting for the completion of a task or operation, such as a file down load from a network, the UI will have one set of UI objects active during the operation. Upon completion of this exemplary file download operation, the global context flags 304 are changed which in turn causes a Boolean compare and finally a new UI comprising new UI objects (Not shown). This type of event-based example is but one of many that does not include any end-user interaction.

This completes the description of the application open graphical interface. It is noted that the programming of all of the different menu commands and their appearance, if needed are as simple as performing a Boolean “AND” when each menu entry is compared to the global context flag.

Changing the appearance of any menu or menu items is now taken to be a simple method of table listing with associated global context flags. Additionally new applications or changes to programs can re-use large and detailed tables rather that starting from scratch.

### OPENING A TEXT FILE

Turning now to FIG. 4 a UI description 400, shows a window with a text file open with the associated global context flags, according to the present invention. At this point the end-user has opened a text file and started to type 412. Therefore the global context flags 404 are Document=open 406, Document type=text 408 and Document Object=text 410. These global context flags represent the state of the opened text file in the window 402. They are presented to the three possible menu lists by the compare functions 312 through 316 for AND'ing.

The File menus 318, new 320 and 322 that were presented at the start of the application continue to be favorably AND'ed and are presented in the file menu 446. Even though a text file is opened additional and different files can be opened and so new 320 and open 322 are valid choices. With this type of multi-application program text files, spreadsheet, and databases can all be opened as different windows. The end-user need not open different applications such as a word processor, spread sheet or data base applications. In addition close 324, save 326 and print 328 now do match 312 using the associated order array of each entry and the global context flags 404 and are presented in the file menu 446.

The Table 330 menu and insert table associative array 332 also do match 314 with the global context flags 404 and are presented to the end user 448. Table menu selections insert row 334 and delete row 336 associative array do not match 314 and are not presented.

The graphic menu 338 and its contents 340-344 associative array do not match 316 and therefore are not presented.

This completes the description of the application with an opened text file. The application window 402 contains File and Table on the menu bar 460. It is noted that comparing the global context flags as the end user changes the state of the window results in changed menu selections, which contextually are correct.

### INSERTING A TABLE

FIG. 5 is UI description 500, shows an open text file with text 412 and a selected table 512. This window results in the global context flags 504 of: document=open 506, document type=text 508, and document object=tab 510. These global context flags are compared 312, 314 and 316 to the file 318, table 330 and graphic 338 associative array menu lists.

The file menu 318 associated associative array is compared to the global context flags 504 which, results in all of the menu selections being listed 546. The file menu allows for the present active text file to be closed 324, saved 326, printed 328 and in addition an additional file can be started 320 or opened 322.

The table menu 330 associative array is compared 314 to the global context flags 504, which results in all of the menu selections being listed 548. As the table is selected 512 the table menu 548 allows for the insertion of a row 334 or a column 336.

In the description given above the end-user is presented a new UI as a result of the end-user selecting a UI object. That is the UI is being changed when a UI object is selected. In an alternate embodiment for event-based triggering, other events can trigger the Boolean comparison to take place with the global context flags 504. such as elapsed time. Stated differently, if no other UI object is selected after a certain amount of time than global context flags 504 are changed. In one example this would result in a password screen UI object being taken away. (Not shown) In another example, depending on the time of day, the global context flags 504 are changed which would result in changes to the UI objects displayed after the Boolean matches. In one example at noon, a lunch message UI object is placed on the end-users screen. (Not shown).

The graphic menu 338 associative array when compared by the Boolean “AND” function 316 to the global context flags 504 results in no menu selections.

This completes the description of the application with an opened text file with the table inserted and active. It is noted that comparing the global context flags as the end-end-user changes the state of the window results in changed menu selections, which contextually are correct and presented in the menu bar 560. In this case the full table menu 548 is available for selection, along side the File menu 546.

### INSERTING A GRAPHIC

FIG. 6 is a UI description 600, shows that a graphic of a dog has just been inserted into the window 602 and is active 612. On this same window are the table 512 and the line of text 412 neither of which are active. The global context flags 604 for this window are document=open 606, document type=text 608, and document object=graphic 610. These global context flags are compared using the associated associative arrays of 312, 314 and 316 to the file 318 table 330 and graphic 338 menu lists.

The file menu 318 associative array as compared to the global context flags 604 results in the selectable menu 646 which includes all file items 320 through 328.

The table menu 330 associative array as compared to the global context flags 604 results in only the table 330 and insert 332 items being listed in the selectable menu 648. This is a result of the document object being changed to graphic as the graphic of the dog 612 is now active rather than the table 512.

The graphic menu 338 associative array as compared to the global context flags 604 results in all of the graphic items: resize 340, flip 342 and rescale 344 being presented to the selectable menu 650.

This completes the description of the application with an opened text file with a graphic inserted and active 612. It is noted that comparing the global context flags as the end-user changes the state of the window results in changed menu selections file 646 table 648 and graphic 650 which selectable in the menu bar 660. In this case the complete graphic menu 650 is available for selection, while the table has a reduced selection.

### FLOW DIAGRAM FOR GLOBAL CONTEXT FLAG BOOLEAN OPERATION

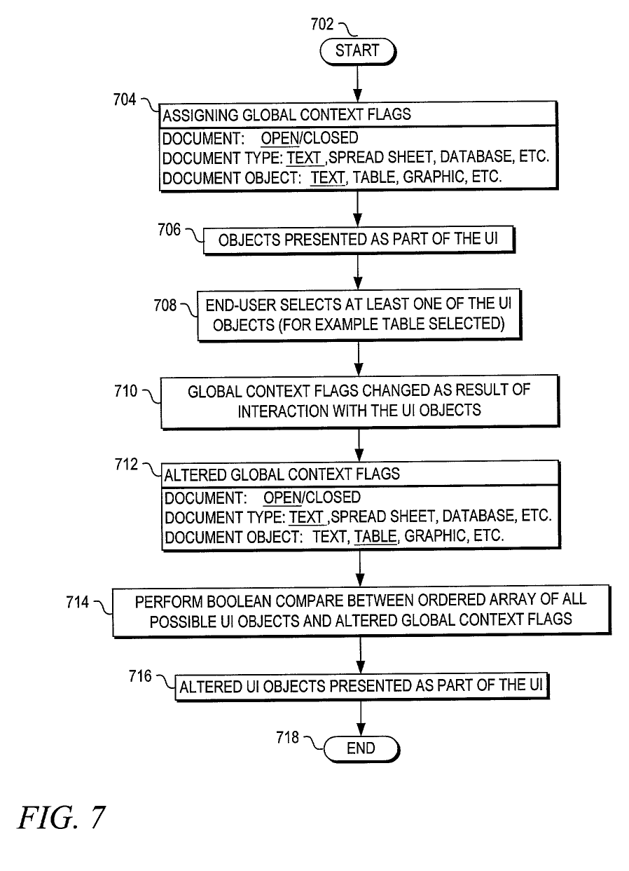

FIG. 7 is a flow diagram 700 shows the operational flow for the control of the UI according to the present invention. The flow is entered at step 702. At this point in time the global context flags that have been assigned at step 704 are: document=open, document type=text and document object=text. The global context flags are used to select the UI objects such as particular icons, and or menu and menu items with which the end-user will interact with the application. The global context flags are compared (312, 314, and 316) using the associative array of each UI object, to the available menu command lists (318, 330 and 338) and are presented to the end-user at step 706 in the window menu bar, along with the opened text file. The end-user selects a UI object presented by the application at step 708 by selecting a table, for example. As a result of this selection at step 708 the global context flags are changed at step 710. The selecting is one example of an interaction. The interaction can be by a keyboard, a pointing device, spoken word or time out. At this point in time the global context flags have changed at step 712 and are document=open, document type=text and document object=table. These are used in a Boolean comparison at step 714 against all possible UI objects using the associative array of each. The altered UI objects are presented as part of the UI to the end-user at step 716. The flow exits at step 718.

Although the preceding examples used a Boolean AND function for the selection of the graphical construct based on the global context flags, it will be appreciated that alternated functions can be used such as an “OR” function or even complex AND/OR variants with out departing from the scope and spirit of the present invention.

### NON-LIMITING EXAMPLES

The term UI is used throughout this present invention to describe any UI including visual output such as CUI and GUI and any input UI including ViBU, VUI and PUI. Moreover, other types of outputs such as multimedia, sound, taste, and smell are within the true scope and spirit of the invention.

Although a specific embodiment of the invention has been disclosed. It will be understood by those having skill in the art that changes can be made to this specific embodiment without departing from the spirit and scope of the invention. The scope of the invention is not to be restricted, therefore, to the specific embodiment, and it is intended that the appended claims cover any and all such applications, modifications, and embodiments within the scope of the present invention.

What is claimed is:

1. A method for presenting zero or more User Interface (UI) objects as part of a UI on an information processing system, the method comprising:
associating an associative array with one or more entries to each of a plurality of UI objects that may be presented as part of a UI;
presenting at least one UI object based on a state of at least one global context flag for the UI;
receiving a response from an end-user to the presentation of the at least one UI object and/or receiving an event-based trigger;
altering the state of the global context flag label based on the response from the end-user;
performing a Boolean comparison between the global context flag and one or more of the entries of in the associative array for each of the UI objects; and
presenting zero or more the plurality of UI objects as part of the UI to the end-user based upon a result of the Boolean comparison.

2. The method according to claim 1, wherein the step of presenting to an end-user the at least one UI object further comprising at least one of the following:
presenting a visual image;
creating a vibration;
playing a sound;
emitting a scent; and
emitting a taste.

3. The method according to claim 1, wherein the step of associating an associative array with one or more entries to each of a plurality of UI objects that may be presented as part of a UI includes associating an associative array with zero or more entries to each of a plurality of UI objects that may be presented as part of a UI by retrieving the associative array from a file when an application using the UI is loading.

4. The method according to claim 1, wherein the global context flags are changed after the application using the UI receives any input from:
an end-user comprising an input from a group of input devices consisting of a keyboard, mouse, pointing device, digitizing pen, light pen, track ball, touch screen, motion detector, chemical sensor, sound sensor, and eye movement sensor.

5. The method according to claim 1, wherein the global context flags are changed after the application using the UI receives an event-based trigger from one or the following events:
a time event comprising an input from a time of day or elapsed time; and
an information processing system event comprising a file status, a printing status, a modem status or a power supply status.

6. The method according to claim 1, wherein the step of performing a Boolean operation is selected from the group of Boolean operations consisting of “AND”, “OR”, and “XOR”.

7. The method according to claim 1, wherein the step of associating one or more attributes to each of a plurality of UI objects from a table so that any changes in the table can be made without recompiling and/or re-linking an application using the UI.

8. An information processing system for presenting zero or more User Interface (UI) objects as part of a UI, the system comprising:
one or more UI objects for forming a UI;
at least one associative array with zero or more entries associated with each one or more UI objects;
at least one output device for presenting the one or more UI objects forming the UI;
at least one input device for receiving a response from an end-user to the presentation of the at least one or more UI objects and/or a response from an event-based trigger;
at least one set of global context flags; and
at least one processor for performing a Boolean comparison between the global context flag and the one or more of the entries of the associative array for each of the UI objects;
wherein the one or more UI objects presented on the output device are updated depending on the results of the Boolean comparison after receiving a response from the end-user and/or the event-based trigger.

9. An information processing system according to claim 8, further comprising at least one input device consisting of a keyboard, mouse, pointing device, digitizing pen, light pen, track ball, touch screen, motion detector, chemical sensor, sound sensor, and eye movement sensor.

10. An information processing system according to claim 8, further comprising at least one output device for:
presenting a visual image;
creating a vibration;
playing a sound;
emitting a scent; and
emitting a taste.

11. A computer readable medium containing programming instructions for the User Interface (UI) objects as part of a UI on a information processing system, the programming instructions comprising programming instructions for:
associating an associative array with one or more entries to each of a plurality of UI objects that may be presented as part of an UI;
presenting at least one UI object based on a state of at least one global context flag for the UI;
receiving a response from an end-user to the presentation of the at least one UI object and/or receiving an event-based trigger;
altering the state of the global context flag label based on the response from the end-user;
performing a Boolean comparison between the global context flag and one or more of the entries of in the associative array for each of the UI objects, and
presenting zero or more the plurality of UI objects as part of the UI to the end-user based upon a result of the Boolean comparison.

12. A computer readable medium according to claim 11, wherein the programming instructions for presenting to an end-user the at least one UI object further comprising at least one of the following:
presenting a visual image;
presenting;
creating a vibration;
playing a sound;
emitting a scent; and
emitting a taste.

13. A computer readable medium according to claim 11, wherein the programming instructions of associating an associative array with one or more entries to each of a plurality of UI objects that may be presented as part of a UI includes programming instructions for associating an associative array with one or more entries to each of a plurality of UI objects that may be presented as part of an UI by retrieving the associative array from a file when an application using the UI is loading.

14. A computer readable medium according to claim 12, wherein the programming instruction wherein the global context flags are programmed to change after the application using the UI receives input programming instructions from:
an end-user comprising an input from a group of input devices consisting of a keyboard, mouse, pointing device, digitizing pen, light pen, track ball, touch screen, motion detector, chemical sensor, sound sensor, and eye movement sensor.

15. A computer readable medium according to claim 12, wherein the global context flags are programmed to change after the application using the UI receives an event-based trigger from one or the following events:
a time event comprising: input from a time of day or elapsed time;
an information processing system event comprising a file status, a printing status, a modem status or a power supply status.

16. A computer readable medium according to claim 12, wherein the programming step of performing a Boolean operation is selected from the group of Boolean operations consisting of “AND”, “OR”, and “XOR”, and NOT.

17. A computer readable medium according to claim 12, wherein the programming step of associating one or more attributes to each of a plurality of UI objects from a table so that any changes in the table can be made without recompiling and/or re-link an application using the UI.
